(19) United States
(12) Patent Application Publication
(10) Pub. No.: US 2006/0263142 A1
(43) Pub. Date: Nov. 23, 2006

(54) Writing instrument with a resilient end

(76) Inventor: Edward Goldberg, Teaneck, NJ (US)

Correspondence Address: KAPLAN GILMAN GIBSON & DERNIER L.L.P., 900 ROUTE 9 NORTH, WOODBRIDGE, NJ, 07095, US

(21) Appl. No.: 11/132,700

(22) Filed: May 19, 2005

(51) Int. Cl. B43K 25/00; B43K 29/00

(52) U.S. Cl. 401/195; 401/52

(57) ABSTRACT

A writing instrument comprises a first end portion having a writing point and a second end portion opposite to the first end portion. The second end portion is capable of bending when an external force is applied thereon and is capable of resuming its initial state when the force is relieved. The second end portion is preferably made of a resilient material. The second end portion may be a plunger that drives the writing point between an exposed position and a retracted position.

### FIELD OF THE INVENTION

The present invention relates to writing instruments, and more particularly, to a writing device having a resilient end for alleviating anxiety of a user.

### DESCRIPTION OF THE PRIOR ART

During writing difficulties and at other times, people often unconsciously try to release or alleviate anxiety or to help thinking by biting the writing instrument, repeatedly hitting the plunger, or even by breaking the writing device. These actions either leave unpleasant appearance on the writing instrument, or make annoying noises or worse, destroy the writing device.

Therefore, there exists a need for a writing instrument that may help to alleviate the anxiety of a user during writing difficulties and at other times, and/or to assist the user in thinking, without above problems of the prior art.

### SUMMARY OF THE INVENTION

To achieve the above objects, the present invention provides a novel writing instrument which comprises a first end portion having a writing point and second end portion opposite to the first end portion, wherein the second end portion is capable of resiliently deforming under an external force. Thus, a user may try to alleviate his or her anxiety or assist his/her thinking, by forcing the resilient second end portion to bend without making noises or damaging the writing instrument.

Preferably, the second end portion is a plunger for driving the writing point to reciprocally move between an exposed, writing position and a retracted, non-writing position.

### BRIEF DESCRIPTION OF THE DRAWINGS

The above and other objects, features and advantages of the present invention will be readily apparent to those of ordinary skill in the art upon a reading of the following detailed description of presently preferred, but nonetheless illustrative, embodiments of the present invention when taken in conjunction with the accompanying drawings, in which:

FIG. 1 schematically illustrates an embodiment of the writing instrument according to the present invention;

FIG. 1a shows an exemplary embodiment of the upper end portion incorporated in the writing instrument;

FIG. 2 shows how the bendable upper end portion in FIG. 1 works;

FIG. 3 schematically illustrates another embodiment of the writing instrument according to the present invention; and

FIG. 4 shows how the grasping portion in FIG. 3 works.

### DESCRIPTION OF THE PREFERRED EMBODIMENT

In the embodiments, same reference numerals refer to the similar elements throughout the drawings.

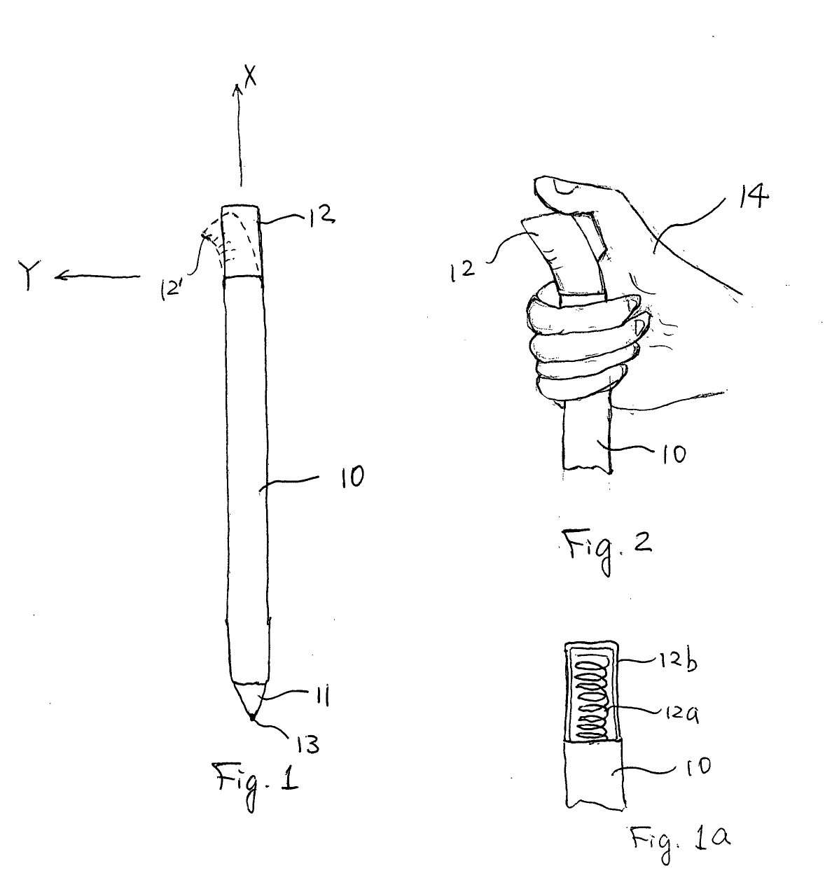

Referring now to FIG. 1, in which an embodiment of the writing instrument according to the present invention is schematically illustrated, the writing instrument may be a pen, a pencil, or any other writing device. It should be noted that if the device is a pencil, the below discussed resilient member at end portion 12 is not an eraser, and is not intended to be an eraser or to function as an eraser. An eraser is a substantially rigid structure when found at the end of a pencil; otherwise it would not be useable as an eraser. Continuing, the writing device generally comprises an elongated body 10, which may be generally cylindrical in shape, but can be in other shapes or configurations. The body comprises two opposite end portions 11 and 12 along its longitudinal axis “X”. The lower or first end portion 11 is provided with a writing point 13, which may be a graphite point in a pencil, or a ball in a ballpoint pen. The body 10 is generally made of a rigid material.

According to the teaching of the present invention, the upper or second end portion 12 of the body 10 is resiliently deformable. For example, when a thumb of a user presses on the upper end portion 12 in the “Y” direction of FIG. 1 (as shown in FIG. 2), the upper end portion 12 will deform in a direction “Y” lateral to the longitudinal axis “X” of the body 10 (as shown in dashed lines 12′ in FIG. 1). After the force from the thumb is relieved, with an inherent resiliency, the upper end portion 12 resumes its initial position. This helps the user to alleviate his or her anxiety during writing difficulties without any unaesthetic deformation of, or damage to, the writing instrument.

The upper end portion 12 may be made of a resilient material with certain inherent resiliency, such as, but not limited to, rubber. Alternatively, the upper end portion 12 may be any structure that is capable of bending under an external force and resuming its initial state when the force is removed. For example, it may comprise a coil spring 12a enclosed in a housing 12b, as shown in FIG. 1a.

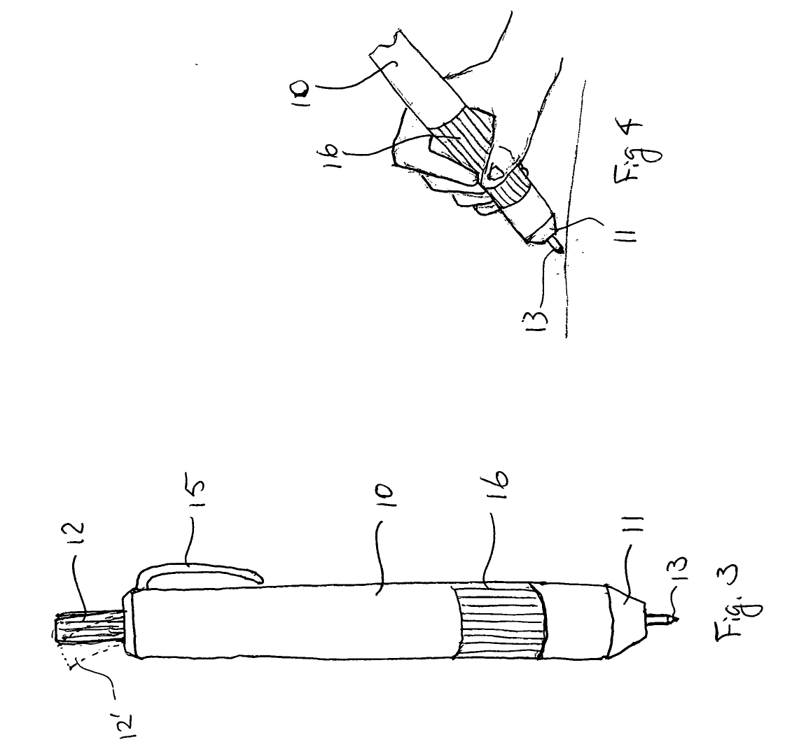

FIG. 3 illustrates another embodiment of the writing instrument according to the present invention. In this embodiment, the writing instrument comprises a plunger 12. When an external force is repeatedly applied on the plunger 12 in a longitudinal direction along the body 10, the plunger 12 drives the writing point 13 to reciprocally move between an exposed position and a retracted position. In the exposed position (as shown in FIGS. 3 and 4), the writing point 13 extends beyond the body 10 so that the instrument is ready for writing, while in the retracted position (not shown) the writing point 13 is completely kept inside the body 10.

According to the teaching of the present invention, the plunger 12 is capable of bending laterally (as shown in dashed lines 12′ in FIG. 3) under an external force laterally applied thereon, such as when it is pressed laterally by a thumb as shown in FIG. 2. Moreover, the plunger 12 is capable of resuming its normal position (shown as in solid lines in FIG. 3) after the external force is removed. The plunger 12 may be made of a resilient material with certain resiliency, such as a rubber, or as shown in FIG. 1a, or by any other means known in the art.

Preferably, the body 10 further comprises a grasping or holding portion 16 at which a user may grasp the writing instrument for writing (see FIG. 4). The grasping portion 16 is usually close to the lower end portion 11. Preferably, the grasping portion 16 is also made of a resilient material and has a non-slippery surface texture for facilitating the user to comfortably hold the body 10 during writing. Preferably, the grasping portion 16 is made of the same material as the plunger 12.

The body 10 may further comprise a clip 15 for attaching the writing instrument to an external item such as a pocket of a shirt.

While preferred embodiments of the writing instrument have been described in detail, it should be apparent that numerous modifications, adaptations and variations thereto are possible to a person skilled in the art without departing from the spirit of the present invention. For example, alternatively or in addition to its capability of bending laterally, the upper end portion 12 in FIG. 1 may be compressive such that it is capable of being compressed when an external force is applied longitudinally thereon, and is capable of resuming its initial shape after the force is relieved.

What is claimed is:

1. A writing instrument, comprising an elongated body having a first end portion with a writing point and a second end portion opposite to said first end portion, wherein said second end portion is capable of resiliently deforming.

2. The writing instrument of claim 1, wherein said second portion is made of a resilient material having a resiliency that said second portion is capable of being deformed when an external force is applied thereon, and of resuming its initial shape when said external force is removed.

3. The writing instrument of claim 2, wherein said second portion is capable of being bent when said external force is applied thereon.

4. The writing instrument of claim 2, wherein said second portion is capable of being compressed when said external force is applied thereon.

5. The writing instrument of claim 3, wherein said second portion is a plunger for driving said writing point to reciprocally move between an exposed position and a retracted position.

6. The writing instrument of claim 1, wherein said body, except said second end portion, is made of a rigid material.

7. The writing instrument of claim 1, wherein said body further comprises a grasping portion for being held by fingers of a user when said user is writing with said writing instrument.

8. The writing instrument of claim 7, wherein said grasping portion is located close to said first end portion.

9. The writing instrument of claim 8, wherein said grasping portion is made of a resilient material.

10. The writing instrument of claim 9, wherein said grasping portion is made of the same resilient material as said second end portion.

11. The writing instrument of claim 10, wherein said grasping portion has a non-slippery surface.

12. The writing instrument of claim 10, wherein said body, except said second end portion and said grasping portion, is made of a rigid material.

13. A writing instrument comprising a body having a first end portion provided with a writing point and a second end portion opposite to said first end, wherein said second end portion is resiliently bendable.

14. The writing instrument of claim 13, wherein said second end portion is made of a resilient material.

15. The writing instrument of claim 14, wherein said second end portion is a plunger for driving said writing point to move between an exposed position in which said writing point extends beyond said body and a retracted position in which said writing position is inside said body.

16. The writing instrument of claim 15, wherein said body further comprises a holding portion facilitating fingers of a user to grasp said writing instrument so as to write with said instrument.

17. The writing instrument of claim 16, wherein said holding portion is made of the same resilient material as said second end portion.

18. The writing instrument of claim 17, wherein said body is made of a rigid material except said second end portion and said holding portion.

19. A device comprising an elongated body having a first end portion provided with a writing point and a second end portion opposite to said first end portion along a longitudinal axis of said body, wherein said second end portion is capable of bending laterally to said longitudinal axis.

20. The device of claim 19, wherein said second end portion is made of a resilient material.
